(19) United States
(12) Patent Application Publication
(10) Pub. No.: US 2021/0003191 A1
(43) Pub. Date: Jan. 7, 2021

(54) SHOCK ABSORBER DEVICE HAVING STRUCTURE FOR CONSTANT-SPEED OPERATION

(71) Applicant: Doo Young YOON, Incheon (KR)

(72) Inventor: Doo Young YOON, Incheon (KR)

(21) Appl. No.: 16/875,948

(22) Filed: May 15, 2020

(30) Foreign Application Priority Data
Jul. 5, 2019 (KR) 10-2019-0081402

(51) Int. Cl. F16F 13/00; F16F 9/06; F16F 9/32; F16F 9/34; F16F 9/44; F16F 9/50

(52) U.S. Cl. CPC F16F 13/007; F16F 9/062; F16F 9/065; B60G 15/061; F16F 9/34; F16F 9/44; F16F 9/50; F16F 9/3235

(57) ABSTRACT

Disclosed herein is a shock absorber device having a structure for constant-speed operation. The shock absorber device having a structure for constant-speed operation includes: a body configured such that an inner cylinder having a plurality of orifices is concentrically accommodated inside an outer cylinder and a piston rod and a spring are connected to a piston that slides in the inner cylinder; an accumulator disposed in a flow passage communicating with the orifices and configured to damp a working fluid; and an adjusting means configured to adjust absorbing force and repelling force to a set range via the piston rod. A connection rod is angle-adjustably provided at at least one end of the body, and the connection rod is connected via a worm gear and an adjusting bolt.

### CROSS-REFERENCE TO RELATED APPLICATIONS

This application claims the benefit of Korean Patent Application No. 10-2019-0081402 filed on Jul. 5, 2019, which is hereby incorporated by reference herein in its entirety.

### TECHNICAL FIELD

The present invention relates to a shock absorber device, and more particularly to a shock absorber device having a structure for constant-speed operation that is capable of performing smooth operation by maintaining absorbing force and repelling force rectilinearly.

### TECHNICAL BACKGROUND

In general, shock absorbers are implemented using an elastic method, a gas & hydraulic method, or a mixture thereof, and are used for vehicle suspensions, door opening/closing shock absorbers, vibration protection devices, etc. Such a shock absorber is compressed while exerting absorbing force under the influence of external force, and is then stretched while exerting repelling force under the influence of energy stored in an accumulator. In order to achieve smoother compression and stretching, efforts have been made to improve the filling material of the shock absorber, to apply multiple orifices, and to adjust the absorbing force from the outside.

In connection with this, as prior art documents for reference, there are known Korean Utility Model Registration No. 0215353 (prior art document 1), Korean Patent No. 1760904 (prior art document 2), etc.

Prior art document 1 discloses a structure in which a narrow-top and wide-bottom tapered portion is provided in the lower portion of the inner side of a piston rod, an orifice is formed in one side thereof, absorbing force is simply adjusted by rotating an adjusting handle disposed on an upper support, and an adjusting valve equipped with an oil seal is installed such that in the process of adjusting absorbing force, the adjusting valve is lifted without being rotated, thereby allowing the effect of reducing the wear and damage of the oil seal to be expected.

Prior art document 2 discloses a structure: including a fluid-filled inner tube and outer tube; a pin member vertically coupled through a body valve, and configured such that an orifice connecting a compression chamber and a storage chamber is formed therein; and a moving member coupled to the upper end of the pin member so as to be selectively lifted and lowered, and configured to adjust the opening sectional area of the orifice. Accordingly, it is expected that the effect of preventing vehicle ride comfort from being deteriorated by preventing excessive clamping is achieved.

However, even when the structures of the above-described prior art documents are applied to a shock absorber, this is insufficient to maintain absorbing force and the repelling force linearly, and thus there is a need for an improvement in terms of the implementation of smooth operation.

### SUMMARY OF INVENTION

The present invention has been conceived to overcome the above-described problems, and an object of the present invention is to provide a shock absorber device having a structure for constant-speed operation that is capable of performing smooth operation in a specific application in conjunction with a configuration for maintaining absorbing force and repelling force rectilinearly based on a method using a plurality of orifices.

In order to accomplish the above object, the present invention provides a shock absorber device having a structure for constant-speed operation, the shock absorber device including: a body configured such that an inner cylinder having a plurality of orifices is concentrically accommodated inside an outer cylinder and a piston rod and a spring are connected to a piston that slides in the inner cylinder, an accumulator disposed in a flow passage communicating with the orifices and configured to damp a working fluid; and an adjusting means configured to adjust absorbing force and repelling force to a set range via the piston rod.

The body may be configured such that the diameters of the orifices are different from each other.

The working fluid accommodated in the body may include gas and oil that are used simultaneously.

The accumulator may include a micro-actuator in order to adjust pressure in response to an external electrical signal.

The adjusting means may include a dial rotatably disposed in an end of the body, an adjusting plate configured to cause a fluctuation in the elastic force of the spring in conjunction with the rotation of the dial, and an adjusting shaft interposed between the dial and the adjusting plate.

A connection rod may be angle-adjustably provided at at least one end of the body, and the connection rod may be connected via a worm gear and an adjusting bolt.

The body may include a plurality of conductive plates accommodated in the outer circumferential surface of the inner cylinder in an axial direction and a permanent magnet fastened to the piston to face the conductive plates, and may damp the working fluid using an eddy current method.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a schematic sectional view showing a shock absorber device according to the present invention;

FIG. 2 is a schematic sectional view showing the operating state of the shock absorber device according to the present invention;

FIG. 3 is a schematic view showing the adjusting means of the shock absorber device according to the present invention; and

FIG. 4 is a schematic view showing a modification of the shock absorber device according to the present invention.

### DETAILED DESCRIPTION

Embodiments of the present invention will be described in detail below with reference to the accompanying drawings.

According to the present invention, there is proposed a shock absorber device having a structure for constant-speed operation. The shock absorber device absorbs shock energy while maintaining constant resisting force over an overall stroke while minimizing shock force (external force) generated from a moving target object, thereby inducing smooth stopping without a rapid fluctuation in speed.

A body 10 according to the present invention is configured such that an inner cylinder 11 having a plurality of orifices 13 is concentrically accommodated in an outer cylinder 12 and a piston rod 16 and a spring 27 are coupled to a piston 15 that slides in the inner cylinder 11. The body 10 may refer to the inner cylinder 11 and the outer cylinder 12 in a narrow sense, and may refer to the inner cylinder 11, the outer cylinder 12, the piston 15, the piston rod 16, and connection rods 17 in a broad sense. The piston 15 is accommodated in the inner cylinder 11 in order to be subjected to the elastic force applied by the spring 27. A flow passage 21 for the flow of a working fluid is formed between the inner cylinder 11 and the outer cylinder 12. The plurality of orifices 13 formed in the inner cylinder 11 is configured to have constant resisting force (absorbing force) over an overall stroke. The connection rods 17 for installation are provided at one end of the outer cylinder 12 and one end of the piston rod 16, respectively.

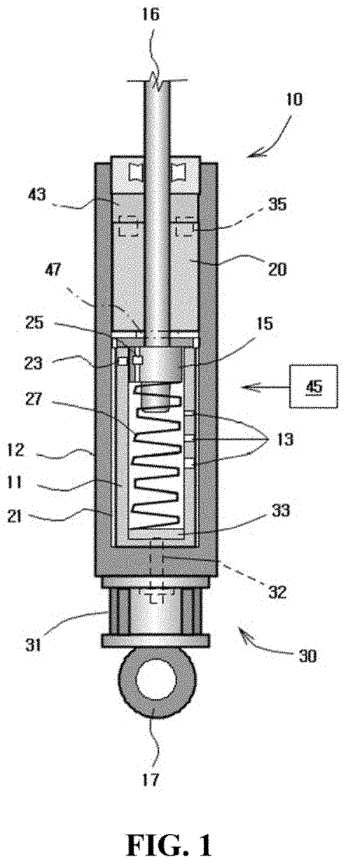

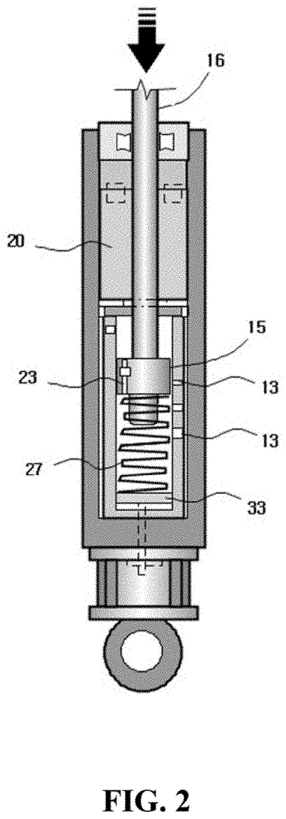

As a detailed configuration of the present invention, the body 10 is characterized in that the diameters of the orifices 13 are different from each other. Referring to FIG. 1, there is illustrated a state in which the uppermost orifice 13 has the smallest diameter and the orifices 13 have larger diameters in a downward direction. As shown in FIGS. 1 and 2, as the piston rod 16 is pushed by external force, the elastic force of the spring 27 increases and the damping force of the orifices 13 decreases, and thus the balance of absorbing force is maintained over an overall stroke. It will be apparent that differences in the diameters of the plurality of orifices 13 may vary depending on a target object to which the device of the present invention is applied.

As a detailed configuration of the present invention, the working fluid accommodated inside the body 10 may include gas and oil that are used at the same time. The gas may be inert nitrogen gas or the like, and the oil may be a mixture of mineral oil and synthetic commonly applied to hydraulic apparatuses. The mixed use of gas and oil is advantageous in that damping force is evenly distributed over the overall stroke. Gas and oil may be accommodated in divided areas within the body 10.

Furthermore, according to the present invention, an accumulator 20 is disposed in the flow passage 21 communicating with the orifices 13, and damps the working fluid. The accumulator 20 employs a diaphragm method for low-pressure use, and employs a piston method for high-pressure use. It will be apparent that both the two methods may be applied to the single outer cylinder 12. The accumulator 20 is accommodated to communicate with the flow passage 21 at a location adjacent to the inner cylinder 11 inside the outer cylinder 12. In the damped state of the rod 16 as shown in FIG. 2, the working fluid of the inner cylinder 11 causes damping while being stored in the accumulator 20 through the plurality of orifices 13 and the flow passage 21. Thereafter, in a process in which the piston rod 16 is repelled, the working fluid stored in the accumulator 20 is returned to the inner cylinder 11 through the flow passage 21, a return hole 23, and the check valve 25 of the piston 15.

As a detailed configuration of the present invention, the accumulator 20 is provided with a micro-actuator 35 in order to adjust pressure in response to an external electrical signal. The micro-actuator 35 equipped with a working rod is accommodated in a guide block 43, and causes the working rod to move up and down inside the accumulator 20. When the fluctuation of external force through the rod 16 is severe, the micro-actuator 35 is operated through a controller 45 to be described later. When a fluctuation in the internal pressure of the accumulator 20 is caused by the operation of the micro-actuator 35, absorbing force and repelling force may be adjusted as a result.

Furthermore, according to the present invention, an adjusting means 30 has a structure that adjusts absorbing force and repelling force to a set range through the piston rod 16. The adjusting means 30 maintains constant absorbing force over the overall stroke of the piston 15 and the piston rod 16, and thus induces a smooth stop without a rapid fluctuation in speed. The adjusting means 30 may adjust not only absorbing force but also repelling force according to a target object to which the device of the present invention is applied.

As a detailed configuration of the present invention, the adjusting means 30 is provided with a dial 31 rotatably disposed on an end of the body 10 and an adjusting plate 33 configured to cause a fluctuation in the elastic force of the spring 27 in conjunction with the rotation of the dial 31. The dial 31 is rotatably accommodated in the end of the outer cylinder 12, and has gradations (not shown) that enable the amount of rotation to be easily identified by the naked eye. The adjusting plate 33 is accommodated in the lower end of the inside of the inner cylinder 11, and supports an end of the spring 27. An adjusting shaft 32 is interposed between the dial 31 and the adjusting plate 33 in order to convert rotational movement into vertical movement. The adjusting shaft 32 is connected to the adjusting plate 33 in an integrated manner, and has spirals on part of the lower end thereof. The dial 31 has a nut that engages with the spirals of the adjusting shaft 32. Accordingly, when the dial 31 is rotated in the state of FIG. 1, the adjusting plate 33 is raised as shown in FIG. 2, thereby increasing the elastic force of the spring 27.

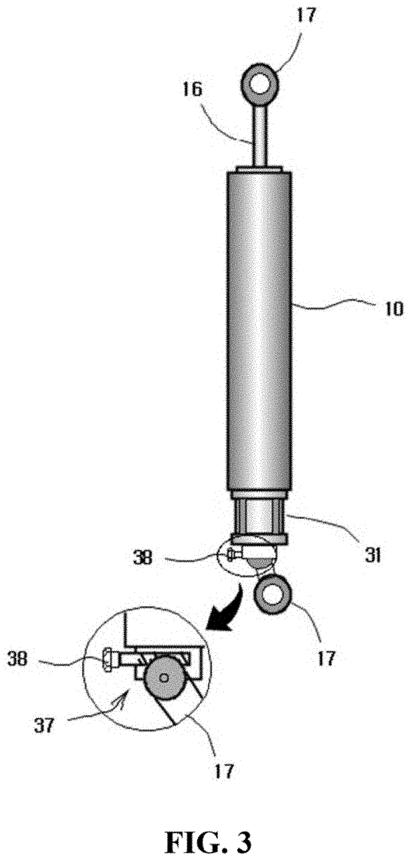

As a detailed configuration of the present invention, the body 10 is provided with the angle-adjustable connection rod 17 at least one end thereof, and the connection rod 17 is coupled to the body 10 via a worm gear 37 and an adjusting bolt 38. A point of action varies depending on the posture in which the device of the present invention is installed on a target object, and thus initial force, absorbing force, and an absorbing/repelling pattern vary. As one method for adjusting this, a change in the angle of the connection rod 17 is preferred. In FIG. 3, there is illustrated the posture in which the connection rod 17 is inclined with respect to the central axis of the body 10 by the worm gear 37 and the adjusting bolt 38. The adjusting bolt 38 is concentrically connected to the worm of the worm gear 37, and the connection rod 17 is fastened to the worm wheel of the worm gear 37. Accordingly, when the adjusting bolt 38 is turned using a tool, a change in the angle of the connection rod 17 is continuously caused through the worm gear 37.

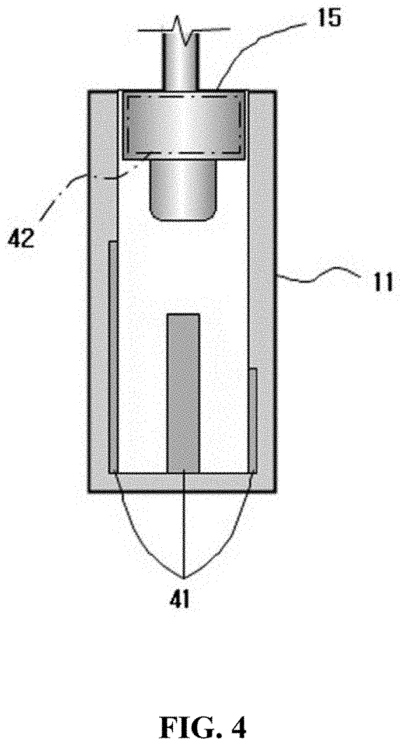

As a modification of the present invention, the body 10 includes a plurality of conductive plates 41 accommodated in the outer circumferential surface of the inner cylinder 11 in an axial direction and a permanent magnet 42 fastened to the piston 15 to face the conductive plates 41, and damps the working fluid using an eddy current method. FIG. 4 shows a state in which the plurality of conductive plates 41 is disposed in the inner surface of the inner cylinder 11 in the axial direction and the permanent magnet 42 is fastened to the outer surface of the piston 15. The conductive plates 41 may be copper plates, and preferably have different lengths. Accordingly, while the piston 15 is being lowered by external force, eddy current braking force (absorbing force) is generated by the conductive plates 41 and the permanent magnet 42. When the conductive plates 41 and the permanent magnet 42 are applied, the function of the spring 27 may be reduced or omitted.

Meanwhile, in the present invention, it is preferable to add the controller 45 and a speed detector 47 in order to perform precise speed control. The controller 45 includes a microprocessor-based microcomputer circuit, and the speed detector 47 is installed to face the stroke region of the piston rod 16. When the controller 45 is applied to the device of the present invention, the damping force is changed by operating the micro-actuator 35 at the moment when a fluctuation in the speed of the rod 16 increases.

As described above, according to the present invention, there are provided the effects of facilitating adjustment for smooth operation in a specific application in conjunction with a configuration for maintaining absorbing force and repelling force rectilinearly based on a method using a plurality of orifices and increasing the reliability of operation.

It will be obvious to those skilled in the art that the present invention is not limited to the described embodiments and may be modified and altered in various manners without departing from the spirit and scope of the present invention. Therefore, such modifications or alienations will be construed as being encompassed by the scope of the attached claims.

What is claimed is:

1. A shock absorber device having a structure for constant-speed operation, the shock absorber device comprising:
a body configured such that an inner cylinder having a plurality of orifices is concentrically accommodated inside an outer cylinder and a piston rod and a spring are connected to a piston that slides in the inner cylinder;
an accumulator disposed in a flow passage communicating with the orifices and configured to damp a working fluid; and
an adjusting means configured to adjust absorbing force and repelling force to a set range via the piston rod;
wherein a connection rod is angle-adjustably provided at at least one end of the body, and the connection rod is connected via a worm gear and an adjusting bolt.

2. The shock absorber device of claim 1,
wherein the body is configured such that diameters of the orifices are different from each other.

3. The shock absorber device of claim 1,
wherein the working fluid accommodated in the body includes gas and oil that are used simultaneously.

4. The shock absorber device of claim 1,
wherein the accumulator comprises a micro-actuator in order to adjust pressure in response to an external electrical signal.

5. The shock absorber device of claim 1,
wherein the adjusting means comprises a dial rotatably disposed in an end of the body, an adjusting plate configured to cause a fluctuation in elastic force of the spring in conjunction with rotation of the dial, and an adjusting shaft interposed between the dial and the adjusting plate.

6. The shock absorber device of claim 1,
wherein the body comprises a plurality of conductive plates accommodated in an outer circumferential surface of the inner cylinder in an axial direction and a permanent magnet fastened to the piston to face the conductive plates, and damps the working fluid using an eddy current method.
